(19) United States
(12) Patent Application Publication
(10) Pub. No.: US 2012/0278460 A1
(43) Pub. Date: Nov. 1, 2012

(54) Association of Source and Cloned Device

(76) Inventor: Matthew Duncan Hastie, La Jolla, CA (US)

(21) Appl. No.: 13/098,254

(22) Filed: Apr. 29, 2011

(51) Int. Cl. G06F 15/173

(52) U.S. Cl. 709/223

(57) ABSTRACT

A method described herein provides for determining at a management device a source device has been cloned to form a cloned device in a cloning process; and storing a genealogical association between the cloned device and the source device. Alternatively, an apparatus described herein may access and initiate execution an operation to be performed on an antecedent device; identify a genealogical relationship; determine that the antecedent device has a common property to a property of the descendent device; and initiate execution of the operation on the descendent device based on the genealogical relationship. Alternatively, a computer-readable medium may store instructions that, when executed, may perform a method including accessing an executable operation to be performed; identifying a device based on a stored association; and executing the operation on the identified device.

### BACKGROUND OF THE INVENTION

Computer systems may be copied to form two or more duplicate computer systems by the act of cloning. Cloning describes the derivation of a new computer from a sequence of bits that describe a source machine.

In environments where cloning is prevalent, it is common for the environment to maintain a set of standardized clone images, or templates, that specify currently known provisioning best-practices. It is common for such best-practices to evolve and change over time. This evolution can lead to environments where machines result in different ‘best-practice’ configurations based on their time of creation, which may not be compliant with the ultimate best practices of the computation environment.

This problem is compounded by the fact that it is possible to clone a template into a virtual machine, and then use that machine as the basis of a new ‘best-practice’ template. This act creates a fan-out of similar but distinct computer systems throughout an environment that may be subtly changed.

### DRAWINGS

FIG. 1. is an example diagram of a source device, a cloned device and a management device in accordance with an example embodiment of the present disclosure.

FIG. 2 is an example flow diagram of a method for storing an association, in accordance with an example embodiment of the present disclosure.

FIG. 3 is an example flow diagram of a method for performing an operation on a device based on a stored association, in accordance with an example disclosure.

FIG. 4 is an example flow diagram of a method for performing an operation on an antecedent device and a descendent device, in accordance with an example embodiment of the present disclosure.

FIG. 5 is an example genealogical tree diagram, in accordance with an example embodiment of the present disclosure.

### DETAILED DESCRIPTION

As discussed herein, when a cloning operation takes place, a cloned device maybe be created from a source device. Upon determining at a management application, operating on a management device, that a cloning operation has taken place, the management application may store an association between the cloned device and the source device thereby storing the genealogical relationship between the cloned device and the source device. This association may indicate that the cloned device is a descendent device of the source, or antecedent, device.

If there is an operation to be performed on a device within a network with respect to an application installed on the device, it may be desirable to identify all of the devices within the network that include the same version history of the software application in order to perform the operation. A cloned device may include an exact copy of the software operating on the source device at the time of the cloning operation. By utilizing the stored genealogical association between the source device and the cloned device, descendent devices of a source device may be identified. Once descendent devices are identified, the operation may be performed on the descendent devices.

### Cloning

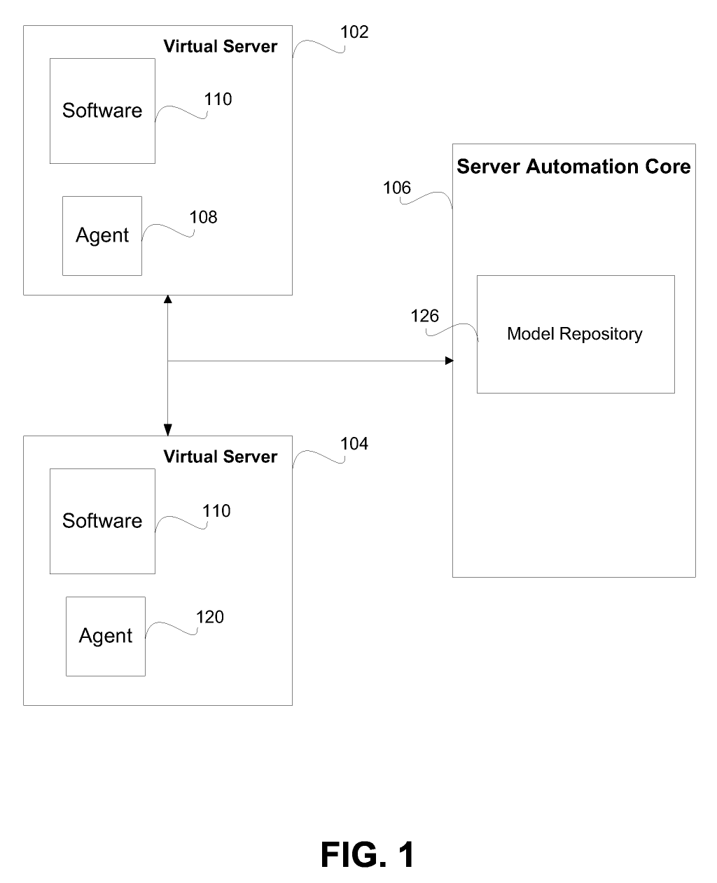

FIG. 1. depicts a diagram of a network including a source device 102, a cloned device 104 and a management device 106 in accordance with an example embodiment of the present disclosure. It may be appreciated that these devices may reside within a network of multiple devices. Source device 102 and cloned device 104 may be, for example, virtual machines implemented in software including computer-readable instructions, executable by a processor and stored in a computer-readable storage medium. The virtual machines may reside on a physical machine that may be implemented through any suitable combinations of software including machine readable instructions, firmware, including machine readable instructions, and/or hardware. The physical machine may include, among other things, a central processing unit, memory, input/output devices, a networking application facilitate communication with other devices, both virtual and physical, within a network, other software applications.

Source device may include software applications 110. For example, software 110 may include Oracle 11i, IIS 7, .NET 3.5 and SharePoint 2007. Source device 102 further includes agent 108, for example, a server automation agent. Agent 108 may communicate with management device 106 and enable management device 106 to manage source device 102.

When a cloning operation takes place, cloned device 104 maybe be created. At the time of cloning, software applications may be duplicated. Software may be duplicated at cloned device 104. Thus, after the cloning operation, the cloned device may include, for example, Oracle 11i, IIS 7, .NET 3.5 and SharePoint 2007 at cloned device 104. Agent 108 of source machine 102 may be reinitialized as agent 120 at the time of clone to facilitate management of the cloned device 104. Management device 106 may be implemented as, for example, a server device and may be implemented through any suitable combinations of software including machine readable instructions, firmware, including machine readable instructions, and/or hardware.

Management device 106 may include a central processing unit, primary and secondary memory. Secondary memory may be implemented within management device 106 and/or may be implemented as external data storage. Primary and/or secondary memory may be computer-readable mediums configurable to store applications as discussed herein. Primary and/or secondary memory may further be configurable to receive an installation pack from an external memory, for example, a portable computer-readable medium, for example, a Compact Disc/Digital Video Disc, etc. Management device 106 may further include input/output devices and application(s) to facilitate communication with and management of managed devices.

Management device 106 may further include model repository 126, which may be implemented as a data storage device that stores management model information of each managed device. A managed device may be any device that the management device may manage, for example, a source device a cloned device, etc. For example, model repository 126 may store, for each managed device, device identification information, agent identification information, properties of the managed device, etc. A property may be a representation of a configuration in the management application where a configuration is a sequence of bits that reside on a managed device. Examples of properties may include a company operating the managed device, a data center associated with the managed device, information identifying software and version histories of the software installed on the managed device and information relating to a version of software installed on the managed device, metadata, information identifying groups the managed device is a member of, etc.

It may be appreciated that while only two managed devices, source device 102 and cloned device 104 are depicted in FIG. 1, additional managed devices may reside in the network and may be communicable with management device 106.

### Associating Source Device and Cloned Device

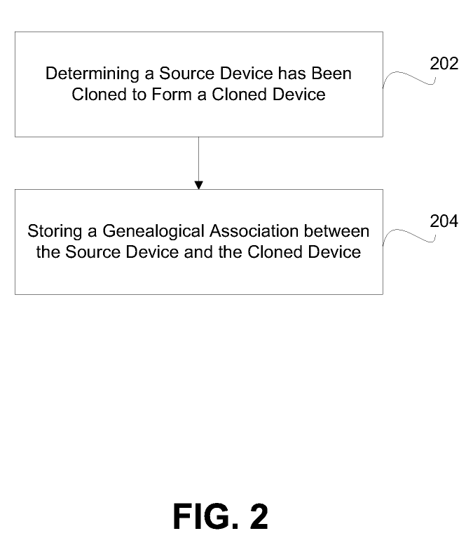

FIG. 2 depicts an example flow diagram describing a method for associating a source device and a cloned device at a management device. As can be seen in FIG. 2, the management device determines a source device has been cloned to form a cloned device in a cloning process (202). At the time the management device makes this determination, a genealogical association is formed between the cloned device and the source device (204).

The cloning process ensures that software applications on the source device are present on the cloned device. By providing for this association, where modification to a configuration needs to take place on the source device, since the cloned device includes the same configuration, the cloned device may be identified based on the cloned device's genealogical association with the source device. This avoids having to search through the model repository for software and version information in order to identify the configuration on the cloned device that needs to be modified.

In addition, based on the association information that is stored identifying genealogical relationships between source and cloned devices, a genealogical tree may be generated by parsing the association information. This information may be generated and graphically displayed on a display of the management device. This provides the ability to graphically represent the genealogical relationship between source devices and cloned devices.

It may be appreciated that the information associating source and cloned devices may persist in the model repository even after a source device or a cloned device is removed from the network. By providing this ability to maintain this information in the model repository, the integrity of genealogical tree may be maintained and cloned devices may still be identified, even though the source device has been removed from the network.

### Performing an Operation Based on Association

By providing the ability to identify cloned, descendent devices of a source device, operations may be performed on descendent devices based on their genealogical relationship with antecedent devices. For example, if it is determined that a particular configuration exists on a source device, since at least direct descendent devices (descendent devices that were directly cloned from the source device) include exact copies of the software that were installed on the source device, the configuration may exist on the direct descendent devices.

In addition or alternatively, it is possible that the configuration may exist on indirect descendent devices (descendent devices that were cloned from a descendent device of the source device). Thus, by verifying one or more properties associated with each of the indirect descendent devices match one or more properties with the source device, the management device 106 may verify that the configuration associated with the property exists on the indirect descendent devices having the same property as the source device.

Alternatively, this verification may be made for direct and indirect descendent devices.

Once it is determined that a configuration exists on a source device, the configuration may, for example, be modified. This configuration modification may be performed to, for example, correct a vulnerability, install a software upgrade, install a patch, etc.

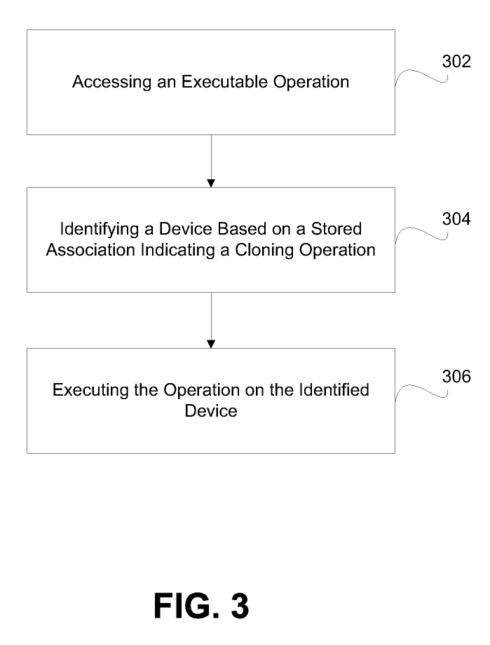

Once descendent device(s) are identified, the same operation that was performed on the source device may be performed to descendent device(s)s based on the stored association with the source device. FIG. 3 depicts an example flow diagram of steps for performing an operation on a device based on a stored association. The operation may be, for example, to modify a configuration, for example, to install a software upgrade, patch, correct a vulnerability, or another operation.

As shown in FIG. 3, an executable operation may be accessed where the executable operation is to be performed within a network of devices (Step 302). A device may be identified within the network of devices based on the stored association of the device with another device. For example, a cloned device may be identified based on its association with a source device (Step 304). The operation may be performed on the identified device (Step 306).

Where an antecedent device no longer exists within the network, the genealogical relationship with descendent devices may still be stored at management device 106. Thus, if it is determined that an operation should be performed on an application at the antecedent device, the descendent device(s) may still be identified and the operation may be performed at the descendent device(s).

### Performing an Operation on an Antecedent Device and a Descendent Device

By providing the ability to identify descendent devices of a source device, operations that may be performed on the source device may be considered to be performed on the descendent devices. For example, where a configuration exists on a source device, a process may be performed to modify the configuration not only on the source device, but also on the descendents of the source device that have the same configuration.

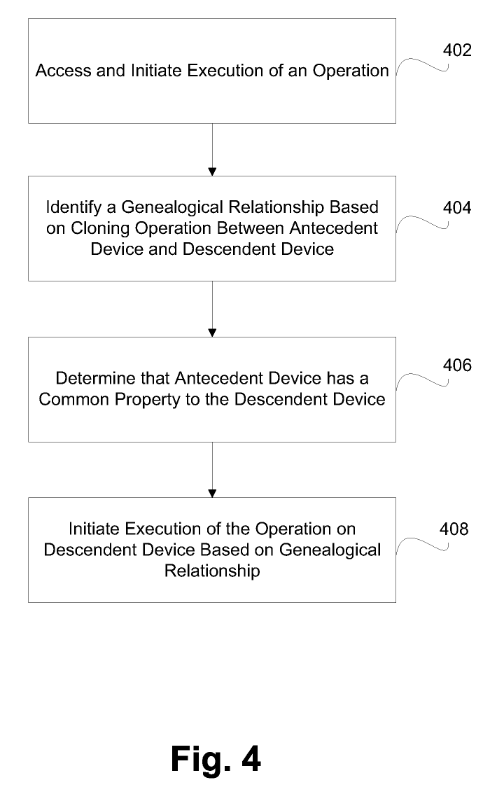

FIG. 4 depicts an example flow diagram of a method for performing an operation on an antecedent device and a descendent device. As shown in FIG. 4, the management device 106 may access and initiate execution an operation to be performed on an antecedent device (Step 402). The management device 106 may identify a genealogical relationship based on a cloning operation between the antecedent device and a descendent device within a network (Step 404).

The management device 106 may then determine that the antecedent device has a common property to a property of the descendent device (Step 406). For example, this may confirm whether the descendent device has the same configuration, for example, software application, same version, etc., that is present on the antecedent device. If the descendent device has the common property to the property of the antecedent device, the management device 106 may initiate execution of the operation performed at the antecedent device on the descendent device based on the genealogical relationship with the antecedent device (Step 408).

### Genealogical Tree

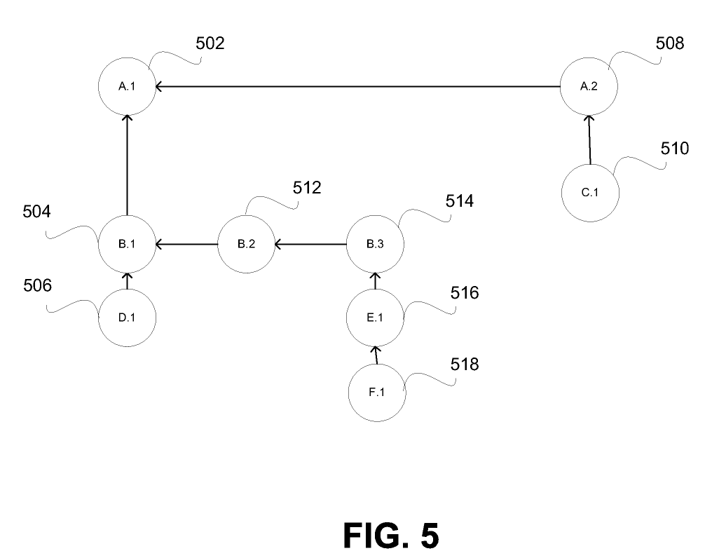

FIG. 5 is an example genealogical tree diagram, in accordance with an example embodiment of the present disclosure. As can be seen from FIG. 5, device A.1 502 is depicted. A represents the device, while the extension, .1, represents the version of the device. A.1 502 was cloned to form B.1 504. B.1 504 was cloned to form D.1 506.

A.1 502 has two different versions. At A.1 502, Oracle 11i was installed. At A.2 508, Patch Red Hat #171284 was installed.

A.2 508 was cloned to form C.1 510.

B.1 504 has three different versions. At device B.1 504, Oracle TNSNAME.ORA was configured. At device B2 512, Finance-Anti-Virus was removed. At device B.3 514, Console session Log L#472912 was created.

B.3 514 was cloned to form E.1 516. E.1 516 was cloned to form F.1 518.

A genealogical tree may be established based on stored associations between source devices and cloned devices. This association may be stored, for example, in a table in the model repository 126. For example, the following table may store associations between source, or antecedent, devices, and cloned, or descendent devices as discussed with respect to FIG. 5:

TABLE
GENEAOLGY

| Antecedent | | Descendent |
|---|---|---|
| SystemID | VersionID | SystemID |
| A | 1 | B |
| A | 2 | C |
| B | 1 | D |
| B | 3 | E |
| E | 1 | F |
| . . . | . . . | . . . |

As can be seen from the Genealogy Table, for example, B is a descendent of A.1, C is a descendent of A.2, etc. This table may include reflexive content, where the reflexive content enables the generation of the genealogical tree.

A Version table may be stored in model repository that stores mutations at different versions of devices. An example of the version table may be as follows:

TABLE
VERSION

| VersionID | SystemID | MutationID |
|---|---|---|
| 1 | A | L |
| 2 | A | M |
| 1 | B | N |
| 2 | B | O |
| 3 | B | P |
| . . . | . . . | . . . |

In addition, a Mutation table may be stored in model repository 126 that identifies the different mutations identified in the Version table. An example Mutation table may be as follows:

TABLE
MUTATION

| MutationID | Function | Object |
|---|---|---|
| L | INSTALL-SOFTWARE | ORACLE 11i |
| M | PATCH-OS | REDHAT P#171284 |
| N | CONFIGURE | ORACLE TNSNAME.ORA |
| O | REMOVE-SOFTWARE | FINANCE-ANTI-VIRUS |
| P | CONSOLE-SESSION | LOG L#472912 |
| . . . | . . . | . . . |

As can be seen from the Version Table, A.1 has mutation ID L. Referring to the Mutation table, mutation ID corresponds to installation of Oracle 11i.

Additional information may be stored in model repository 126. For example, hardware device inventory and associated metadata, software applications and versions and associated metadata, etc. present at the device may be stored with respect to each device. This information may be utilized to determine whether operations at antecedent devices should be performed at descendent devices.

Alternatively, the information stored in these tables may be stored in different configurations in one or more tables within model repository 126.

Based on the information stored in these tables, a genealogical search can identify all descendents of a device. Thus, if it is determined that an operation should be performed at one device, all of the descendents that were created from the device may be identified, and the operation may be performed at the descendent devices.

For example, it if were determined that a non-desirable change, or mutation, occurred at B.1 504, where the file ORACLE TNSNAME.ORA installed on B.1 504 had a particular configuration, using the information stored in the tables, descendants D.1 506, E.1 516 and F.1 518 may be identified. The operation to modify the configuration in ORACLE TNSNAME.ORA at B.1 504 may also be performed at D.1 506, E.1 516 and F.1 518 based on the association of these descendent devices to antecedent device B.1 504.

It may further be appreciated that if the configuration of ORACLE TNSNAME.ORA were identified at E.1 516, using the tables stored, it may be determined that ORACLE TNSNAME.ORA was installed at B.1 504, and thus, B.1 504 may be the source of the change. Based on this identification, instead of merely identifying F.1 518, as the descendent of E.1 516, as also having this configuration, B.1 504 and B.1's 504 descendent D.1 506 may also be identified as having the configuration. Thus, devices having configurations within the network may be more thoroughly and easily detected and corrected.

I claim:

1. A method, comprising:
determining at a management device a source device has been cloned to form a cloned device in a cloning process; and
storing a genealogical association between the cloned device and the source device.

2. The method of claim 1, wherein the source device and the cloned device reside within a network of a plurality of other devices, and wherein a subset of the plurality of other devices are a plurality of cloned devices where each of the plurality of cloned devices is associated with a source device from which the cloned device was cloned, the method further comprising:
storing at the management device properties of each of the cloned device, the source device and the plurality of other devices in the network, wherein the properties of the source device are the same as the properties of the cloned device.

3. The method of claim 2, further comprising:
identifying a configuration at one of the source device, the cloned device or one of the plurality of other devices in the network;
identifying a plurality of descendent devices of the identified one of the source device, the cloned device or one of the plurality of other devices based on association stored for each of the plurality of descendent devices; and
performing an operation to modify a configuration on each of the identified plurality of descendent devices.

4. The method of claim 1, further comprising:
identifying the cloned device based on the stored association with the source device; and
performing an operation on the cloned device identified based on the stored association with the source device.

5. The method of claim 4, wherein the operation modifies a configuration on the cloned device.

6. The method of claim 4, wherein the source device and the cloned device reside within a network of a plurality of other devices, and wherein a subset of the plurality of other devices are cloned devices where each of the cloned devices is associated with a source device from which the cloned device was cloned, the method further comprising:
identifying a plurality of descendent devices of the source device in the network based on associations stored for each of the plurality of descendent devices;
determining whether the source device has a common property to a property of each of the plurality of descendent devices; and
performing an operation on the identified plurality of descendent devices based on the determination that the source device has a common property of the plurality of descendent devices.

7. The method of claim 1, further comprising:
identifying the source device based on the association between the cloned device and the source device;
determining that the source device has a common property to a property of the cloned device; and
performing an operation on the identified source device based on the determination that the source device has a common property of the cloned device.

8. The method of claim 7, wherein the operation modifies a configuration on the source device.

9. A non-transitory computer-readable medium, storing a set of instructions executable by a processor to perform a method comprising:
accessing an executable operation to be performed within a network of devices;
identifying a device within the network of devices based on a stored association of the device with another device, wherein the association indicates a cloning operation; and
executing the operation on the identified device.

10. The non-transitory computer-readable medium method of claim 9, wherein the operation modifies a configuration on the device.

11. The non-transitory computer-readable medium of claim 9, wherein the another device no longer resides within the network of devices.

12. The non-transitory computer-readable medium of claim 9, wherein the association is stored when a management application determines a cloning process has taken place.

13. The non-transitory computer-readable medium of claim 9, the method further comprising:
determining whether the identified device has a common property to a property of the another device; and
performing an operation on the another device based on the determination that the identified device has a common property of the another device.

14. The non-transitory computer-readable medium of claim 13, wherein the at least one device is an antecedent device of the at least one device.

15. An apparatus, comprising memory storing a set of processor-executable instructions, and a processor for executing the stored instructions that, when executed, cause the processor to:
access and initiate execution of an operation to be performed on an antecedent device;
identify a genealogical relationship based on a cloning operation between the antecedent device and a descendent device within a network;
determine that the antecedent device has a common property to a property of the descendent device; and
initiate execution of the operation performed at the antecedent device on the descendent device based on the genealogical relationship with the antecedent device.

16. The apparatus of claim 15, wherein the memory stores instructions that, when executed, cause the processor to:
determine that the descendent device was cloned from the antecedent device; and
based on the determination that the descendent device was cloned from the antecedent device, store the genealogical relationship by storing an association between the descendent device and the antecedent device.

17. The apparatus of claim 15, wherein the operation modifies a configuration at the antecedent device and the descendent device.

18. The apparatus of claim 15, wherein the memory stores instructions that, when executed, cause the processor to:
identify a genealogical relationship between the antecedent device and a device that is antecedent to the antecedent device within the network;
determine that the device antecedent to the antecedent device has a common property to a property of the antecedent device; and
initiate execution of the operation performed at the antecedent device on the device antecedent to the antecedent device based on the genealogical relationship with the antecedent device.

19. The apparatus of claim 18, wherein the memory stores instructions that, when executed, cause the processor to:
identify a different descendent device to the device that is antecedent to the antecedent device based on a genealogical relationship between the device that is antecedent to the antecedent device and the different descendent device;
determine that the different descendent device has the common property; and
initiate execution of the operation performed at the device antecedent to the antecedent device on the different descendent based on the genealogical relationship with the antecedent device.

20. The apparatus of claim 19, wherein the memory stores instructions that, when executed, cause the processor to:
generate a genealogical tree based on the stored associations of the descendent device, the antecedent device, the device that is antecedent to the antecedent device and the different descendent device.
